(19) United States
(12) Patent Application Publication
(10) Pub. No.: US 2015/0347093 A1
(43) Pub. Date: Dec. 3, 2015

(54) Provisioning Tools for Application Development

(71) Applicant: HEWLETT-PACKARD DEVELOPMENT COMPANY, L.P., Houston, TX (US)

(72) Inventors: Sean DOWD, McKinney, TX (US); Bart LEETEN, Mechelen (BE); Chandra KAMALAKANTHA, Plano, TX (US); Mathias SALLE, Palo Alto, CA (US); Sanjay LOBO, Plano, TX (US); Michael SMITH, Austin, TX (US); Dan BERTRAND, Oxford, MI (US); Shi XIN, Shanghai (CN)

(21) Appl. No.: 14/651,185

(22) PCT Filed: Dec. 11, 2012
(86) PCT No.: PCT/US2012/068978

§ 371 Date: Jun. 10, 2015

(51) Int. Cl. G06F 9/44; H04L 29/08

(52) U.S. Cl. CPC G06F 8/20; G06F 8/33; H04L 67/02

(57) ABSTRACT

An exemplary embodiment of the present invention may include a method of provisioning tools for application development. The method may include receiving parameters of a project. The method ma also include provisioning components through a network based on the parameters, the components including a source code management module to receive code related to the project, a continuous integration module to maintain code integration, and a virtual machine installed on a client device to enable a user to interact with other components. The method may also include communicatively coupling each of the source code management module, the continuous integration module, and the virtual machine to each other.

### TECHNICAL FIELD

The present technique relates generally to a method of provisioning tools for application development. More specifically, the present technique relates to a computing system configured to enable a virtual machine to interact with modules in a network environment, the modules being configured based on parameters of the application to be developed.

### BACKGROUND

Software development projects typically begin with few if any tools in place to support a mature development process. A team may be assigned a project related to development of an application or program to be implemented in a business or other enterprise environment. As the team's project progresses, tools may be required to support a more mature process. The tools then may need to be integrated with each other and with individual developer tools to allow developers to work on the project.

### BRIEF DESCRIPTION OF THE DRAWINGS

Certain exemplary embodiments are described in the following detailed description and in reference to the drawings, in which:

FIG. 1 is a block diagram of a computing environment in which tools may be provisioned for application development;

FIG. 2 is a block diagram of a system for provisioning tools for application development;

FIG. 3 is a process flow diagram of a method for provisioning tools for application development; and

FIG. 4 is a tangible, non-transitory, computer-readable medium configured to provision tools for application development.

### DETAILED DESCRIPTION OF SPECIFIC EMBODIMENTS

In some environments software development may require the provisioning of tools, also referred to herein as modules. Some software development may include development of enterprise application software used in an organization, such as in a business or a government agency. The development of software, including enterprise application software may require steps related to hardware such as ordering a server, unpacking the server, configuring the server, and the like. Enterprise application software development may also require the provisioning of a tool on the server such as a module associated with a source code repository. A second server may need to be ordered, unpacked, and configured to enable a continuous integration module to be installed thereon. The continuous integration module may need to be configured to communicate with the module associated with the source code repository. Further, a communication method or channel between the source code repository and one or more software developers on a software development team may need to be established.

The present techniques may enable the provisioning of software development tools on servers of a cloud computing network upon receiving the parameters of the project. Rather than requiring individuals to order, unpack, and configure a server in relation to a software development project, pre-existing networked servers of a cloud computing environment may be used. In addition to using pre-existing networked servers, the servers may be preconfigured with modules such as a source code management module, a continuous integration module, and the like. Further, the modules may be configured to be communicatively coupled to each other based on the dependencies of a model environment associated with application development. In addition, a software developer may be able to communicate with the modules located on the networked servers via a virtual machine on a client device, such as any computing device.

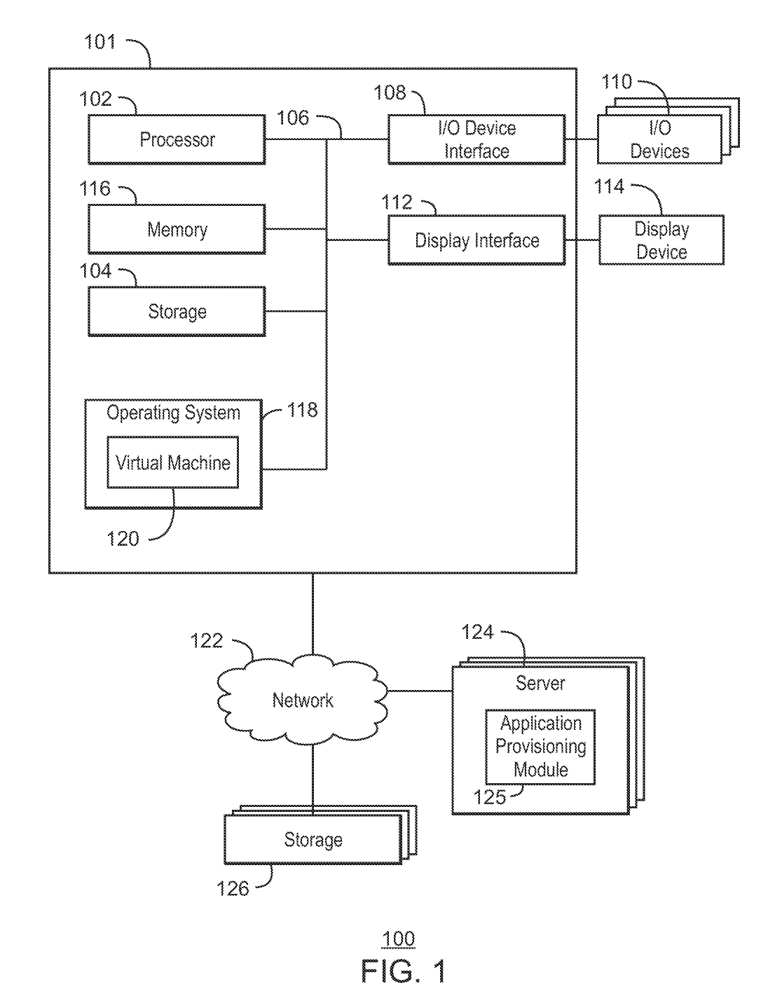

FIG. 1 is a block diagram of a computing environment 100 in which tools may be provisioned for application development. The computing environment 100 may include a computing device 101, and may be, for example, a laptop computer, desktop computer, tablet computer, mobile device, server, or cellular phone, among others. The computing device 101 may include a processor 102 that is adapted to execute stored instructions, as well as a storage device 104 that stores instructions that are executable by the processor 102.

The processor 102 can be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU). In some embodiments, the processor 102 includes dual-core processor(s), dual-core mobile processor(s), or the like.

The processor 102 may be connected through a system bus 106 (for example, PCI, ISA, PCI-Express, HyperTransport®, NuBus, among others) to an Input/Output (I/O) device interface 108 adapted to connect the computing device 101 to one or more I/O devices 110. The I/O devices 110 may include, for example, a keyboard and a pointing device, wherein the pointing device may include a touchpad or a touchscreen, among others. The I/O devices 110 may be built-in components of the computing device 101, or may be devices that are externally connected to the computing device 101.

The processor 102 may also be linked through the system bus 106 to a display interface 112 adapted to connect the computing device 101 to a display device 114. The display device 114 may include a display screen that is a built-in component of the computing device 101. The display device 114 may also include a computer monitor, television, or projector, among others, that is externally connected to the computing device 101.

The computing device 101 may also include a memory device 116. The memory device 116 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems.

The storage device 104 may include a physical memory such as a hard drive, an optical drive, a flash drive, an array of drives, or any combinations thereof. The storage device 104 may also include remote storage drives. The storage device 104 may store instructions thereon to allow the computing device 101 to load and install a host operating system 118 on the computing device.

The host operating system 118 may be configured to manage computer hardware resources and provide for common services of computer programs that require the host operating system 118 to function on the computing device 101. The host operating system 118 may also include a virtual machine 120 configured to allow a user, such as a software developer, to communicate with various modules located on various servers of a network 122. The virtual machine 120, as referred to herein, is a simulation of a machine, such as computing device 101, configured to provide a system platform to support the execution of an operating system within a host operating system 118. The virtual machine 120 may be implemented with either software emulation or hardware virtualization or any combination thereof. The virtual machine 120 may, via the computing device, be communicatively coupled to the network 122. The network 122 may be a communication network and may include a local area network (LAN), a wide area network (WAN), the Internet, or any combination thereof. The network 122 may communicatively couple one or more servers 124, as well as one or more storage devices 126, to the computing device 101. The storage devices 126 may be located on the servers 124 or remotely, and may include a physical memory such as a hard drive, an optical drive, a flash drive, an array of drives, or any combinations thereof. The one or more servers 124 may include an application provisioning module 124. The application provisioning module 124 may be configured to provision components related to development of an application through the network 122. By communicatively coupling the computing device 101 to the servers 124 and storage devices 126 via the network 122, the software developer may utilize the computing environment 100 in FIG. 1 to access tools at the application provisioning module 124.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

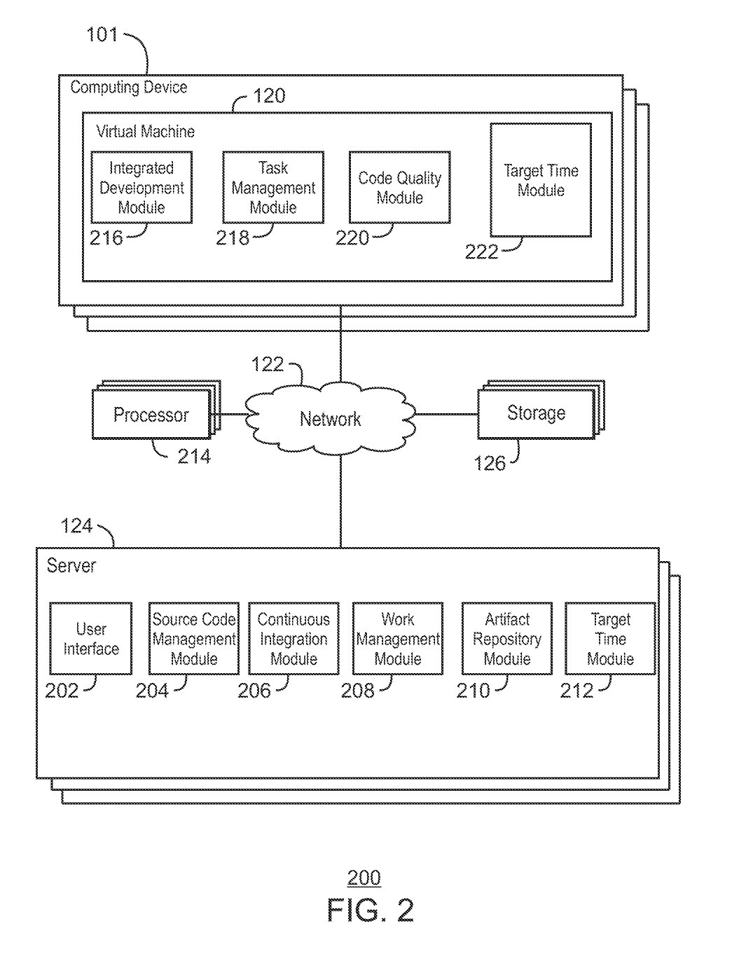

FIG. 2 is block diagram of a system for provisioning tools for application development. Provisioning the components through the network 122 may include downloading the components from the network 122, unpacking the components, installing the components on one or more servers 124 of the network 122, configuring components based on parameters of the project, and integrating components relative to each other. In some embodiments, some of the components may be preinstalled one the one or more servers 124 and provisioning may merely include configuring the components and integrating the components.

The modules for application development may include a user interface 202, a source code management module 204, a continuous integration module 206, a work management module 208, an artifact repository module 210, a target time module 212, and the like. The modules 202, 204, 206, 208, 210, 212 may all be installed on one of the one or more servers 124. Alternatively, any one the modules 202, 204, 206, 208, 210, 212 may be installed on any one of the one or more servers 124. In some embodiments, the one or more servers 124 are communicatively coupled to each other enabling the source code management module 204 to be communicatively coupled to the continuous integration module 206, for example.

The user interface 202 on the server 124 may be a graphical user interface (GUI) configured to enable a user of the system 200 to enter the parameters of a project. The parameters may include project specific requirements including customizable options related to the components used in the system 200.

In some embodiments, the one or more computing devices 101 may be a client device configured to enable a virtual machine 120 to be installed thereon. As mentioned above, the virtual machine 120 may enable an operating system to be installed and run within a host operating system of the computing device 101.

The virtual machine 120 may enable a user, such as a code developer, to interact with the other components such as the source code management module 204 and the continuous integration module 206 of the one or more servers 124. The virtual machine 120 may be provisioned by installing the virtual machine 120 on the client device 101. In some embodiments, the virtual machine 120 may be provisioned by configuring dependencies of the virtual machine 120 in relation to the other components within the network 122. The virtual machine 120 may be initialized with baseline components to monitor other components, either on the virtual machine 120 or on the server 124. The virtual machine 120 may enable the code developer to download and install a pre-integrated model environment for establishing tools associated with application development. The virtual machine 120 may include various components including an integrated development module 216, a task management module 218, a code quality module 220, a target time module 222, or any combination thereof.

The modules 216, 218, 220, 222 of the virtual machine 120 may be configured to communicate with the modules 202, 204, 206, 208, 210, 212 of the one or more servers 124. The virtual machine 120 may be communicatively coupled to the network 122. The network 122 may be configured to enable the virtual machine 120 to communicate to the one or more servers 124 and the storage device 126. The storage device 126 may be configured to store instructions for provisioning components through the network 122 based on parameters of a project for developing an application or software, including enterprise software.

The network 122 may communicatively couple the one or more computing devices 101 and the one or more servers 124 to one or more processors 214 configured to execute the stored instructions to receive parameters of the project. The processors 214 may be located at one or more of the servers 124, or at the computing device 101. The parameters may include host names, administrative account details, security parameters, and the like. The processor 214 may also execute the stored instructions to provision components on a server 124 through the network 122. The components may include the source code repository 204, the continuous integration module 206, and the virtual machine 120 installed on a client device such as one of the one or more computing devices 101. The processor 214 may also execute the stored instructions to communicatively couple each of the source code management module 204, the continuous integration module 206, and various components of the virtual machine 120 to each other.

The source code management module 204 may be configured to receive code related to the project. The source code management module 204 may include an associated source code repository where source code for the project may be stored. The source code management module 204 may be configured to receive various versions of code in an organized fashion from a code developer using the virtual machine 120.

The continuous integration module 206 may be configured to maintain code integration. Continuous code integration may refer to a process of integrating new code that has been developed with existing source code that has already been developed and stored in the source code repository associated with the source code management module 204. The continuous code integration process may include a build process wherein the code is built into the existing source code. The continuous integration module 206 may commit new code to the source code repository, and build the new code into the existing source code such that errors may be noticed and corrected by the code developer. A code developer may, via the integrated development module 216, create the new code, and provide the new code to the continuous integration module 206. In some embodiments, the integrated development module 216 may be configured to enable the code developer to access the source code repository via the continuous integration module 206, wherein the continuous integration module 206 may commit and build the new code to verify whether or not any errors or inconsistencies exist on the server side of the system 200. In some embodiments, the virtual machine 120 may include a code quality module 220 configured to review code for defects at the virtual machine on the client-side of the system 200 before providing the code to the source code repository associated with the source code management module 204.

In some embodiments, the processor 214 may also execute the stored instructions to manage the order that the components are provisioned by determining dependencies of the components relative to each other. For example, the continuous integration module 206 may be installed after the source code management module 204 is installed because the continuous integration module 206 may be dependent on the source code repository of the source code management module 204.

In some embodiments, the source code management module 204 and the continuous integration module 206 may be pre-integrated with each other. Pre-integration may include establishing dependencies between the source code management module 204 and the continuous integration module 206 before project parameters are received. By pre-integrating the modules 202, 204 a code developer may accessed the modules 202, 204 via the virtual machine 120 relatively quickly than if the dependencies between the modules 202, 204 were established at each instance of receiving project parameters. By enabling the processor 214 to execute the stored instructions the provisioning and integration process may be described as a pre-integrated model environment for establishing tools associated with application development.

The server 124 may include a work management module 208 configured to store project requirements, project defects, and a log of work to be performed on the project. In some embodiments, the work management module 208 may communicate with a task management module 218 on the virtual machine 120. The task management module 218 may be configured to provide the project requirements, project defects, and the log of work to be performed, and the like to the code developer from the work management module 208.

The server may include a target time module 212 configured to mimic the run-time of an application as closely as possible. The target time module 222 may also be configured to communicate with the target time module 222 on the virtual machine 120. The target time module 222 may be configured to be used by a developer to run an application that has been built and monitor the application for defects in a run-time environment. The target time module 212 is configured to communicate instructions related to a run-time environment from the server 124 to target time module 222 of the virtual machine 120. Likewise, the target time module 222 of the virtual machine 120 is configured to communicate instructions to initiate and run specific run-time environments for each individual project.

The server 124 may also include an artifact repository module 210. The artifact repository module 210 may be configured to store compiled code used by a portion of the project. The artifact repository module 210 may be accessible by the virtual machine 120. In some embodiments, the artifact repository module 210 may include portions of code that have been determined by an administrator, or other project manager, to be acceptable. For example, a project may require the development of a Java Archive (JAR) file to aggregate many Java class files and associated metadata into one file, and to distribute libraries on the Java platform. The administrator of the project may determine by designation a standardized JAR file for the project, even if an updated version of the JAR file is released elsewhere. This enables code to be developed and designated as the standardized code to be used in any additional code development related the project.

In some embodiments, the parameters of the project may include details relating to the type of module to be selected. The project may customizable according to predetermined criteria comprising vendor-specific module types, dependencies of the components relative to each other, and access to the source code management module 202 and the continuous integration module 204 by one or more users fulfilling different roles in relation to the project.

For example, a client may request that certain vendor-specific types of components be used. A source code management module may include various vendor-specific types including Apache Subversion (SVN), Concurrent Version Systems (CVS), a source code management system with an emphasis on speed such as Git, and the like. Therefore, the project may customizable according to predetermined criteria comprising vendor-specific module types, dependencies of the components relative to each other, and access to the source code management module and the continuous integration module by one or more users fulfilling different roles in relation to the project.

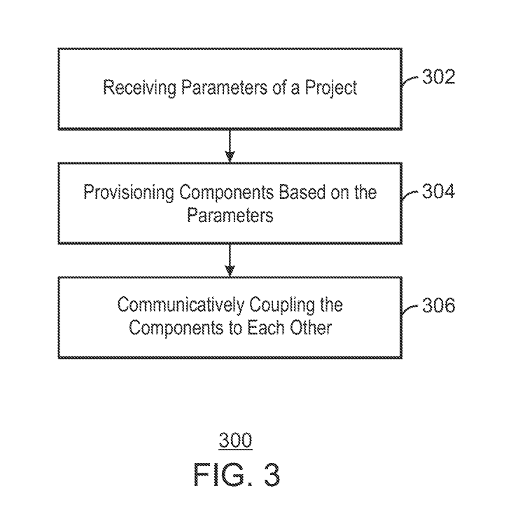

FIG. 3 is a process flow diagram of a method 300 for provisioning tools for application development. The method 300 may be executed by receiving parameters of a project at block 302. The method 300 may also include provisioning components based on the parameters at block 304. The method 300 may also include communicatively coupling the components to each other 306.

At block 302, the parameters may be received by a user of the system and may include various details including requirements of the project. At block 304, the provisioning of components may be accomplished over a network based on the parameters. The components may include a source code management module, a continuous integration module, and a virtual machine installed on a client device. The method 300 may also include provisioning the components according to a pre-integrated model including the relative dependencies of one component to another. The method may also include managing the order the components are provisioned by determining the dependencies of the components relative to each other. For example, the virtual machine may be provisioned and installed after the source code management module and the continuous integration module have been provisioned and installed.

At block 306, the components may be communicatively coupled to each other via a network, such as the network 122 of FIGS. 1 and 2. The network may communicatively couple components installed on one or more servers to computing devices, having virtual machines installed thereon. The source code management module may be configured to receive code related to the project. The continuous integration module may be configured to maintain code integration and build new instances of the code into the existing code to verify that inconsistencies or errors do not exist. The virtual machine may be configured to enable a user, such as code developer to interact with the other components. The virtual machine may, itself, have additional components installed including an integrated development module configured to modify code related to the project in communication with the continuous integration and build module of the network. The virtual machine may also include a task management module configured to provide the project requirements, project defects, and the log of work to be performed on the project from a work management module located in the network on one or more servers. The virtual machine may also include a code quality review module configured to review for defects in the code at the virtual machine before providing the code to a source code repository associated with the source code management module.

The network may include one or more servers, one or more processors, and one or more storage devices. The one or more servers may include additional components useful in carrying out the development of software or an application. For example, the provisioned components may also include a work management module, and an artifact repository module, such as the work management module 208 and the artifact repository module 210 discussed above with reference to FIG. 2. The work management module may be configured to store project requirements, project defects, and a log of work to be performed on the project. In some embodiments, the work management module may be communicatively coupled to the task management module of the virtual machine. The artifact repository may be configured to store compiled code used by a portion of the project. In other words, the artifact repository may store portions of code that have been compiled and are designated by an administrator or other project manager as the standardized version of the code. The artifact repository may include a collect of software artifacts and metadata stored in a defined directory structure, and may be used by a code developer in portions of the project to maintain continuity of the code portion.

Examples of a computing device as referred to herein may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

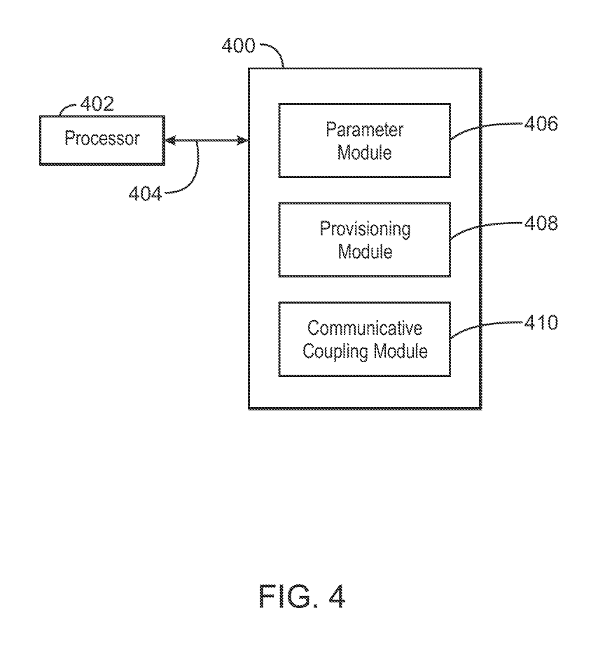

FIG. 4 is a tangible, non-transitory, computer-readable medium configured to provision tools for application development. The tangible, non-transitory, computer-readable medium 400 may be accessed by a processor 402 over a computer bus 404. Furthermore, the tangible, non-transitory, computer-readable medium 400 may include code configured to direct the processor 402 to perform the methods described herein.

The various software components discussed herein may be stored on the tangible, non-transitory computer-readable medium 400, as indicated in FIG. 4. For example, a parameter module 406 may be configured to receive parameters of a software application development project. A provisioning module 408 may be configured to provision various components on a network based on the parameters. The components may include a source code management module to receive code related to the project, a continuous integration module to maintain code integration, and a virtual machine installed on a client device to enable a code developer to interact with the other components. A communicative coupling module 410 may be configured to communicatively couple each of the source code management module, the continuous integrations module, and the virtual machine to each other. In some embodiments, the components may be communicatively coupled to each other according to a predetermined model environment related to application development. The predetermined model may infer dependencies of one component to another. For example, the predetermined model may infer that the continuous integration module may be dependent to the source code management module. In other words, the continuous integration module may require reference to a source code repository associated with the source code management module. Every instance of new code developed may be referenced against existing code associated with the source code management module. In some embodiments, the continuous integration module may, in cooperation with the source code management module, confirm that the new code does not conflict with the existing code by creating inconsistencies, errors, or bugs.

In some embodiments, the provisioning of components may include downloading components from the network, unpacking the components, and installing the components on one or more servers of the network. In some embodiments, some of the components, such as the source code management module and the continuous integration module may already be downloaded, unpacked, and installed. In these and other embodiments, the provisioning may include additional steps including configuring the components based on the parameters of the project, and integrating the components based on dependencies of the components relative to each other.

In the preceding description and the following claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the technique s. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement or order of circuit elements or other features illustrated in the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams or state diagrams may have been used herein to describe embodiments, the techniques are not limited to those diagrams or to corresponding descriptions herein. For example, flow may not move through each illustrated box or state or in exactly the same order as illustrated and described herein.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. A method, comprising:
receiving parameters of a project;
provisioning components through a network based on the parameters, the components including a source code management module to receive code related to the project, a continuous integration module to maintain code integration, and a virtual machine installed on a client device to enable a user to interact with the provisioned components; and
communicatively coupling each of the source code management module, the continuous integration module, and the virtual machine to each other.

2. The method of claim 1, further comprising managing the order in which the components are provisioned by determining dependencies of the components relative to each other.

3. The method of claim 1, wherein the provisioned components further comprise:
a work management module on a server of the network to store project requirements, project defects, and a log of work to be performed on the project; and
an artifact repository module on the server of the network to store compiled code used by a portion of the project.

4. The method of claim 3, wherein the virtual machine comprises:
an integrated development environment module to modify code related to the project;
a task management module to provide the project requirements, project defects, and the log of work to be performed on the project from the work management module; and
a code quality module to review code for defects at the virtual machine before providing the code to a source code repository associated with the source code management module.

5. The method of claim 1, wherein the virtual machine is provisioned by installing the virtual machine on the client device, and initializing the virtual machine with baseline components to monitor the provisioned components.

6. The method of claim 1, wherein the project is customizable according to predetermined criteria comprising vendor-specific module types, dependencies of the components relative to each other, and access to the source code management module and the continuous integration module by one or more users fulfilling different roles in relation to the project.

7. The method of claim 1, wherein provisioning components through the network comprises:
downloading components from the network;
unpacking the components;
installing the components on one or more servers of the network;
configuring the components based on parameters of the project; and
integrating the components based on dependencies of the components relative to each other.

8. A computing system, comprising:
a processor;
a storage device, to store instructions thereon, that when executed by the processor directs the processor to:
receive parameters of the project;
provision components through a network, the components including a source code management module to receive code related to the project, a continuous integration module to maintain code integration, and a virtual machine installed on a client device to enable a user to interact with the other components; and
communicatively couple each of the source code management module, the continuous integration module, and the virtual machine to each other.

9. The computing system of claim 8, wherein the provisioned components further comprise:
a work management module on a server of the network to store project requirements, project defects, and a log of work to be performed on the project; and
an artifact repository module on the server of the network to store compiled code used by a portion of the project.

10. The computing system of claim 9, wherein the virtual machine further comprises additional components comprising:
an integrated development environment module to modify code related to the project;
a task management module to provide the project requirements, project defects, and the log of work to be performed on the project from the work management module; and
a code quality module to review code for defects at the virtual machine before providing the code to a source code repository associated with the source code management module.

11. The computing system of claim 8, wherein the project is customizable according to predetermined criteria comprising vendor-specific module types, dependencies of the components relative to each other, and access to the source code management module and the continuous integration module by one or more users fulfilling different roles in relation to the project.

12. At least one computer-readable medium having instructions stored therein that, in response to being executed on a network device, cause the network device to:
receive parameters of a project;
provision components on a network based on the parameters, the components including a source code management module to receive code related to the project, a continuous integration module to maintain code integration, and a virtual machine installed on a client device to enable a user to interact with the other components; and
communicatively couple each of the source code management module, the continuous integration module, and the virtual machine to each other.

13. The at least one computer-readable medium of claim 12, wherein the instructions further cause the network device to manage the order that the components are provisioned by determining dependencies of the components relative to each other.

14. The at least one computer-readable medium of claim 12, wherein the provisioned components further comprise:
a work management module on a server of the network to store project requirements, project defects, and a log of work to be performed on the project; and
an artifact repository module on the server of the network to store compiled code used by a portion of the project.

15. The at least one computer-readable medium of claim 14, wherein the virtual machine further comprises additional components comprising:
an integrated development environment module to modify code related to the project;
a task management module to provide the project requirements, project defects, and the log of work to be performed on the project from the work management module; and
a code quality module to review code for defects at the virtual machine before providing the code to the source code repository.
